(19) United States
(12) Patent Application Publication
(10) Pub. No.: US 2016/0118819 A1
(43) Pub. Date: Apr. 28, 2016

(54) SECURITY SYSTEM FOR AN ACCUMULATOR BATTERY MODULE AND CORRESPONDING METHOD FOR BALANCING A BATTERY MODULE

(71) Applicant: COMMISSARIAT À L'ÉNERGIE ATOMIQUE ET AUX ÉNERGIES ALTERNATIVES, Paris (FR)

(72) Inventors: Daniel CHATROUX, Teche (FR); Sebastien CARCOUET, Vif (FR); Eric FERNANDEZ, Saint Paul de Varces (FR)

(73) Assignee: COMMISSARIAT À L'ÉNERGIE ATOMIQUE ET AUX ÉNERGIES ALTERNATIVES, Paris (FR)

(21) Appl. No.: 14/889,046

(22) PCT Filed: May 7, 2014
(86) PCT No.: PCT/EP14/59399

§ 371 Date: Nov. 4, 2015

(30) Foreign Application Priority Data
May 9, 2013 (FR) 1354217

(51) Int. Cl. H02J 7/00; H01M 10/46

(52) U.S. Cl. CPC H02J 7/0019; H01M 10/46; H02J 7/0026; H02J 7/0021

(57) ABSTRACT

A security system for a battery module includes at least one battery module having positive and negative poles and defined by a matrix comprising two or more columns and two or more lines. The matrix is such that each column defines an accumulator branch having m accumulators in series and such that each line of the matrix defines an accumulator stage. At least one charge control device is connected to the poles of the battery module. The battery module includes a plurality of resistors respectively electrically linked to the intermediate point between two accumulators of two adjacent accumulator stages and a third predefined number of connection nodes respectively connected to a set of resistors connected to the intermediate points of the accumulators of the two adjacent accumulator stages. The charge control device is connected to the set of connection nodes.

The invention relates to electrochemical accumulator battery modules, for example used in the field of electric and hybrid transport or embedded systems. The invention relates also to a method for balancing such an accumulator battery module.

The invention can also be applied to supercapacitors.

The hybrid combustion/electric or all-electric vehicles notably include batteries of high power used to drive an electric motor with alternating current via an inverter. The voltage levels necessary for such motors reach several hundreds of volts, typically of the order of 400 volts. Such batteries also have a high storage capacity in order to favor the battery life of the vehicle in electric mode.

The electrochemical accumulators used for such vehicles are generally of the lithium-ion type for their capacity to store significant energy with contained weight and volume. In particular, the battery technologies of lithium-ion iron phosphate LiFePO4 type are the subject of significant developments through their high intrinsic protection level compared to the conventional cobalt oxide-based lithium-ion batteries.

To obtain high powers and storage capacities, a number of accumulator groups are placed in series. The number of accumulator stages and the number of accumulators in parallel in each stage vary as a function of the desired voltage, current and storage capacity. The association of a number of accumulators is hereinafter called battery module.

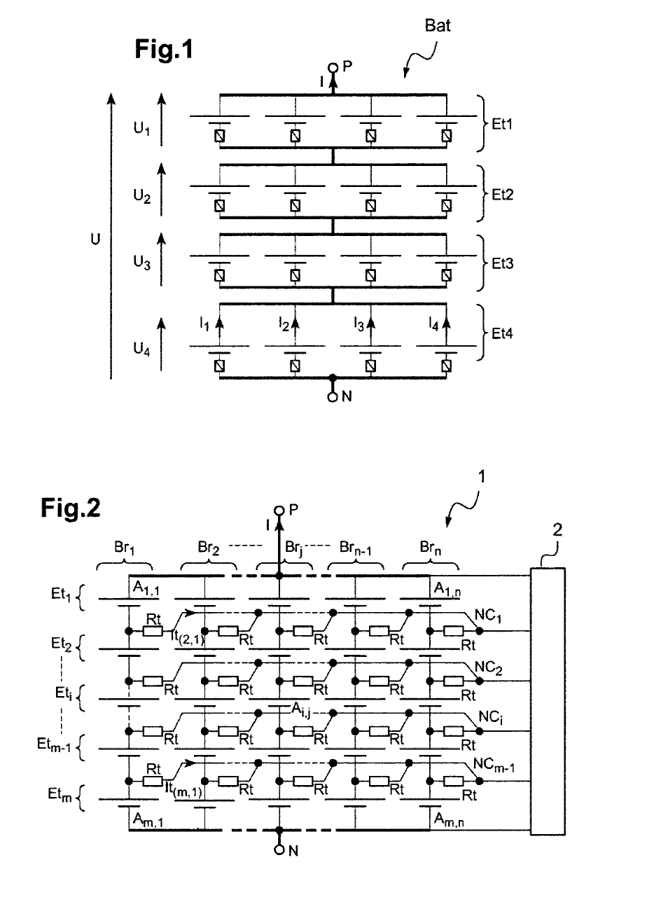

As is known, as illustrated in FIG. 1, such a battery module Bat comprises a number of accumulator stages, for example four stages Et₁, Et₂, Etₐ and Et₄, connected in series. Each stage comprises, for example, at least two, for example four, accumulators that are generally similar, connected in parallel.

The voltage at the terminals of the four stages is respectively denoted U1, U2, U3 and U4. In this scheme, the total voltage U between the N and P terminals of the battery module 1 is the sum of the voltages U1, U2, U3 and U4. The current passing through each accumulator of the fourth stage Et4 is respectively denoted I1, I2, I3 and I4. The current I generated by the terminal P of the battery module Bat is the sum of the currents I1, I2, I3 and I4.

The charging of an accumulator is reflected in an increase in the voltage at its terminals. An accumulator is considered to be charged when the latter has reached a voltage level defined by the electrochemical process.

If the charging is stopped before this voltage is reached, the accumulator is not fully charged.

It is therefore important to monitor in detail the voltage of each accumulator during charging and discharging.

In effect, certain battery technologies (NimH, NiCd) naturally clip the voltage at their terminals by virtue of a stray chemical reaction within the alkaline electrolyte and can continue to be passed through by a current when their high voltage threshold has been reached. The other accumulators, not yet fully charged, may continue to be charged by the current. The voltage clipping is then done by internal electrochemical reactions other than the electrochemical reaction of operation of the accumulator and this is accompanied by heat dissipation.

On the other hand, other types of technology such as lithium-ion do not naturally clip. There is no other electrochemical reaction to ensure a clipping of the voltage with dissipation of the energy. It is absolutely essential to interrupt the current passing through the accumulator to avoid damage to it or its total destruction.

For the cobalt oxide-based lithium-ion accumulators, the overcharging of an accumulator can lead to its thermal runaway and cause a fire to start. For a phosphate-based accumulator an overcharging is reflected in a breakdown of the electrolyte which reduces its life or may damage the accumulator, but without the attendant risk of fire.

Furthermore, the lithium-ion-type accumulators exhibit a minimum voltage that must not be fallen below to avoid degrading the accumulator.

Thus, it is absolutely essential to stop the discharging of the battery module when the least charged accumulator reaches its low voltage threshold. Conversely during charging, the latter must be stopped when the most charged accumulator has reached its high voltage threshold.

However, if the charging is simply stopped when the most charged accumulator reaches its threshold voltage, the other accumulators may not be fully charged. The current must then be diverted for the latter to circumvent the most charged accumulator and continue to charge the other accumulators of the circuit.

Similarly, when discharging, once the least charged accumulator is discharged, energy must if possible be provided to it in order to be able to continue to discharge the other accumulators without damaging the first.

These current diversion and dissipation or energy input functions can be all the more complex or of high powers when the battery accumulators are dispersed in terms of storage capacity.

In the case of the use of battery accumulators which do not naturally clip, like the lithium-ion accumulators, it is necessary to associate an ancillary balancing circuit with each accumulator.

Conventionally, the parallel connections of branches of accumulators comprising accumulators connected in series, of lithium-ion type that do not naturally clip, are not used because a clipping function must be associated with each accumulator and the charging thereof must be controlled. Most such circuits exhibit a high cost and have a great impact on bulk.

One solution consists in using battery modules comprising series arrangements of accumulator stages comprising accumulators connected in parallel, as in the example of FIG. 1.

However, if the battery accumulators used to produce this circuit do not naturally clip, it is necessary to add, for each stage, an ancillary balancing and charge control circuit, for all the stages to be able to be charged correctly.

Moreover, throughout the life of the battery module, certain defects may appear on certain accumulators that make up the battery module. A defect on one accumulator is generally reflected either by the short-circuiting of the accumulator, or by an open-circuiting, or by a significant leakage current in the accumulator. It is important to know the impact of the failure of an accumulator on the battery module. An open-circuiting or short-circuiting can provoke an overall failure of all the battery module.

In the case of the appearance of a significant leakage current in an accumulator of a stage, the battery module behaves like a resistor which provokes a discharging of the accumulators of the stage concerned to zero. The risks of starting a fire are low because the energy is dissipated relatively slowly. In lithium-ion technology, the discharging of the accumulators of the stage to a zero voltage damages them which means replacing them in addition to the initially failing accumulator.

When an accumulator forms a short-circuit, the other accumulators of the stage discharge into this accumulator, because of the large section of the electrical connections between them. This discharging occurs rapidly with an energy dissipation which is reflected in an overheating of the short-circuited accumulator and of the accumulators which discharge into the short-circuit. This can cause a fire to start.

This situation presents a strong danger with the cobalt oxide-based lithium-ion technologies and can be problematical for the iron phosphate-based lithium-ion technologies if the parallel connection relates to a large number of accumulators which add up to a high energy which is dissipated into the short-circuited accumulator.

Moreover, in a battery module formed by a parallel connection of branches of accumulators comprising accumulators connected in series, in the event of malfunction with an accumulator of a branch of accumulators in series short-circuiting, the voltage of the other branches is distributed over the accumulators of the faulty branch.

In particular, for the standard cobalt oxide-based lithium-ion accumulators, such an overvoltage leads to a cascading failure of the accumulators with a strong risk of a fire starting.

Faced with these above-mentioned drawbacks, certain prior art solutions adopt protection for each accumulator by a fuse in series.

The addition of fuses in series with the accumulators as represented in FIG. 1 effectively ensure a protection against the accumulator defects (short-circuits).

The fuse placed in series with the short-circuited accumulator will interrupt the stray discharging of the other three accumulators.

In order to protect the battery module Bat from the consequences of a short-circuit in an accumulator, each accumulator has a fuse which is connected to it in series.

The fuse protection operates on the principle of the melting of a metal conductor passed through by an electrical current. When an accumulator forms a short-circuit, the current passing through it increases substantially and causes its fuse in series to melt in order to protect the rest of the battery module Bat.

However, the individual fuses in series with each accumulator generate a high cost (component and assembly) since these protections are rated for the nominal current of the accumulators.

Furthermore, the presence of the fuses in series between the accumulator stages is detrimental to the efficiency and induces not-inconsiderable losses, a particular handicap for embedded applications. In effect, these fuses in series with the accumulators add an internal resistance to the battery module, hence additional losses which lower its performance levels.

In order to remedy these drawbacks, a solution has been proposed in the document WO2011/003924 that makes it possible to eliminate the losses induced by a protection system in the normal operation of the battery module, and that further makes it possible to ensure a continuity of service of the battery module when an accumulator of the battery module is short-circuited or open-circuited.

In this document, the battery module comprises at least first and second branches each having at least first and second accumulators connected in series. The battery module further comprises a fuse via which the first accumulators of the branches are connected in parallel and via which the second accumulators of the branches are also connected in parallel. The breaking threshold of the fuse is rated to open when one of the accumulators is short-circuited.

However, during a rapid recharge when the vehicle is stopped by connecting the battery module to the electrical network or when operating the electric motor as generator while the vehicle is running, not-inconsiderable recharging or balancing currents may be applied to the accumulators. The fuses connected in the parallel connections can thus be passed through by relatively high currents.

Furthermore, in the event of a malfunction, it emerged that little current flowed in the accumulators of the stage when the latter are far away from the short-circuited accumulator. This therefore requires fusible wires to be implemented that have relatively low melting currents, for example less than 2 A, and that are therefore relatively resistive (>50 mohms). This is not a problem for low balancing currents in slow recharging mode but can become more problematic when balancing in rapid recharging mode when the currents involved are of the order of a few amps. This may therefore cause the fusible wire to melt or at least overwork it causing significant thermal losses.

Furthermore, certain fuses may be passed through by the aggregate of the recharging or balancing currents intended for a number of accumulators of the same stage and remote from the recharging connection. Certain fuses may thus represent a common connection of a number of accumulators to the balancing circuit. Consequently, the rating of the fuses of the parallel connections can prove difficult to ensure equally the protection of the accumulators, the continuity of service of the battery module upon a malfunction of an accumulator and the recharging of the different accumulators.

The life of the fuses can also be shortened by the repeated application of charging currents passing through them.

Conventionally, either by a direct parallel connection of the accumulators or with the aid of fuses, all the voltages of the accumulators of a same given stage are equal. It is then sufficient to have a single voltage measurement to know the voltage of each accumulator of the given stage.

The invention aims to at least partially resolve these drawbacks of the prior art.

To this end, the subject of the invention is a protection system for a battery module, said system comprising:
at least one battery module having a positive pole and a negative pole and defined by a matrix comprising a first predefined number n of columns, n being greater than or equal to two, and a second predefined number m of rows, m being greater than or equal to two, the matrix being such that:
   each column defines a branch of accumulators having m accumulators in series, the branches of accumulators being linked by their ends in parallel and to the poles of the battery module, and such that
   each row of the matrix defines an accumulator stage, and
at least one charge control device connected to the poles of the battery module,
   characterized in that:
the battery module further comprises:
   a plurality of resistors respectively linked electrically to the intermediate point between two accumulators of two adjacent accumulator stages and
   a third predefined number p of connection nodes respectively connected to a set of n resistors connected to the intermediate points of the accumulators of the two adjacent accumulator stages, and
in that the charge control device is connected to all the connection nodes.

The rows of resistors thus make it possible to connect each accumulator stage to a connection node common to all the n resistors of a row of resistors. According to the invention, the voltage measurement at a connection node common to n resistors informs on the average voltage of a stage. In effect, there is no parallel connection of the accumulators such that the voltages of the accumulators of a same given stage are slightly different.

The charge control device connected to all the connection nodes can thus monitor the state of charge of all the accumulator stages by tracking their average voltage at the connection nodes. A single charge control device is needed for all the accumulator stages.

With this solution, there is no need to associate a clipping function with each accumulator and control the charging of the accumulators individually. This makes it possible to reduce the cost of the system and reduce the bulk thereof.

The effect of this invention is thus to benefit from the protection of the parallel connections of accumulators in series and from the simplicity of the voltage balancing and monitoring systems.

Moreover, when the accumulators are similar and in the same state of charge or discharge, in normal operation without a faulty accumulator, the resistors are not passed through by any current.

Finally, the resistors are simple components that make it possible to limit the short-circuit current in the event of an accumulator fault. A higher degree of protection is thus obtained simply for a lesser cost than the solutions of the prior art with fuses for example.

According to one embodiment, said resistors are identical. With the identical resistors linking each accumulator stage to a connection node, the voltage measured at the connection node necessarily corresponds to the average voltage of the accumulator stage.

According to one aspect of the invention, the accumulators are of lithium-ion iron phosphate LiFePO4 type. The accumulators according to the LiFePO4 technology generally having an end-of-charge voltage of the order of 3.6 V can withstand an overvoltage before reaching the destruction voltage of the order of 4.5 V. Such an overvoltage can notably occur in the case of malfunction with a short-circuited accumulator.

According to another aspect of the invention, the charge control device comprises at least one balancing circuit linked electrically to all the connection nodes.

The balancing circuit connected to the connection nodes can therefore monitor the state of charge of each accumulator stage and control the balancing progressively, for example as soon as one stage reaches the plateau voltage added to a chosen threshold. This threshold can be increased up to the end-of-charge voltage.

According to a particular embodiment, the second predefined number m of rows of the matrix and the third predefined number p of connection nodes bear out the following relationship: p=m−1. Each row of n resistors is therefore arranged between two accumulator stages. This reduces the bulk and the number of components.

According to one aspect of the invention, the balancing circuit comprises a plurality of balancing resistors respectively connected in series with a switch, the assembly comprising a balancing resistor and a switch in series being arranged in parallel to an accumulator stage by being connected to at least one connection node.

According to a first embodiment, the balancing circuit comprises m identical first balancing resistors respectively associated with an accumulator stage.

According to a second embodiment, the balancing circuit comprises:
first balancing resistors respectively in series with a switch and associated with an intermediate stage by being connected to at least one connection node and
two second balancing resistors respectively in series with a switch and associated with an end accumulator stage by being connected to at least one connection node and to a pole of the battery module, and a second balancing resistor being in accordance with the formula:

$${Req}^{′} = Req + \frac{Rt}{n} .$$

In the particular case where the first balancing resistors are zero, the balancing circuit comprises:
switches respectively associated with an intermediate stage by being connected to at least one connection node and
two balancing resistors of value

$$\frac{Rt}{n}$$

respectively in series with a switch and associated with an end accumulator stage by being connected to at least one connection node and to a pole of the battery module.

According to a third embodiment, the system comprises n resistors connected to the terminals of the accumulators of each end stage which are linked to a pole of the battery module, and the balancing circuit comprises a plurality of switches respectively associated with an accumulator stage.

According to another aspect of the invention, the charge control device comprises an average voltage measuring device linked electrically to the terminals of the battery module and to all the connection nodes and suitable for measuring the average voltages of the accumulator stages.

Said control device is for example configured to detect a malfunction of the battery module by tracking the average voltage at the terminals of the accumulator stages. It is therefore not necessary to wait for a stage to be fully discharged to detect a malfunction. This detection can be done rapidly.

Said control device is for example configured to detect a malfunction of the battery module when the average voltage at the terminals of at least one of said accumulator stages diverges from the average voltages at the terminals of the other accumulator stages.

Said control device can be configured to detect a malfunction of the battery module when the average voltage at the terminals of at least one accumulator stage drops and the average voltages of the other accumulator stages increase.

Said control device is for example configured to detect a malfunction of the battery module in case of discharge of at least one accumulator stage.

The control device can comprise a charger of the battery module and the average voltage measuring device can control the charger to stop the charging of the battery module, for example when the average voltages of the stages have to be balanced.

The average voltage measuring device can also completely stop the charger when all the stages have reached the end-of-charge voltage.

According to another aspect of the invention, the system comprises at least two battery modules arranged in series, and an isolating device respectively associated with each battery module and comprising a first switch and a second switch. The first switch is arranged in series with the associated battery module and configured to be closed when the associated battery module is operational and open in case of malfunction of said battery module, and the second switch is arranged to bypass the associated battery module and configured to be open when the associated battery module is operational and closed in case of malfunction of said battery module.

Said control device is for example suitable for applying a signal controlling the opening of the first switch and for applying a signal for controlling the closure of the second switch associated with a battery module in case of detection of a malfunction of said battery module.

The isolating device makes it possible to easily isolate one of the battery modules, for example in the case of malfunction with a short-circuited accumulator. The other battery modules can continue to be used which ensures a certain continuity of service.

The invention relates also to a method for balancing a battery module of a system as defined previously, said method comprising the following steps:
a balancing trigger threshold is determined,
the average voltage of the accumulator stages is monitored at the connection nodes,
at least one accumulator stage is detected for which the average voltage reaches a predefined plateau voltage added to the determined balancing trigger threshold,
the charging of the battery module is stopped when the average voltage of at least one accumulator stage reaches a predefined plateau voltage added to the determined balancing trigger threshold,
the average voltages of the accumulator stages are compared with one another,
at least one accumulator stage of average voltage lower than the average voltage of the other accumulator stages is determined,
the closure of the switch in parallel with each accumulator stage of average voltage higher than the accumulator stage determined to be of lower average voltage is ordered, such that the accumulators (A_{i,j}) of the accumulator stages of higher average voltage are discharged through the balancing circuit, and
the charging of the battery module is recommenced when the balance is reached between the average voltages of all the accumulator stages of the battery module.

According to one embodiment, the determination of the balancing trigger threshold comprises the following steps:
the difference between the plateau voltage and a predefined end-of-charge voltage is determined,
said difference is divided by a predefined number n of accumulators in an accumulator stage, the result obtained being said balancing trigger threshold.

According to one aspect of the invention, the threshold to be added to the plateau voltage is progressively increased until a predefined end-of-charge voltage is reached.

Other features and advantages of the invention will emerge clearly from the following description, given by way of indication and in a non-limiting manner, with reference to the attached drawings in which:

FIG. 1 is a schematic representation of a system comprising an example of a battery and balancing circuit according to the prior art;

FIG. 2 is a schematic representation of a system comprising a battery module according to the invention;

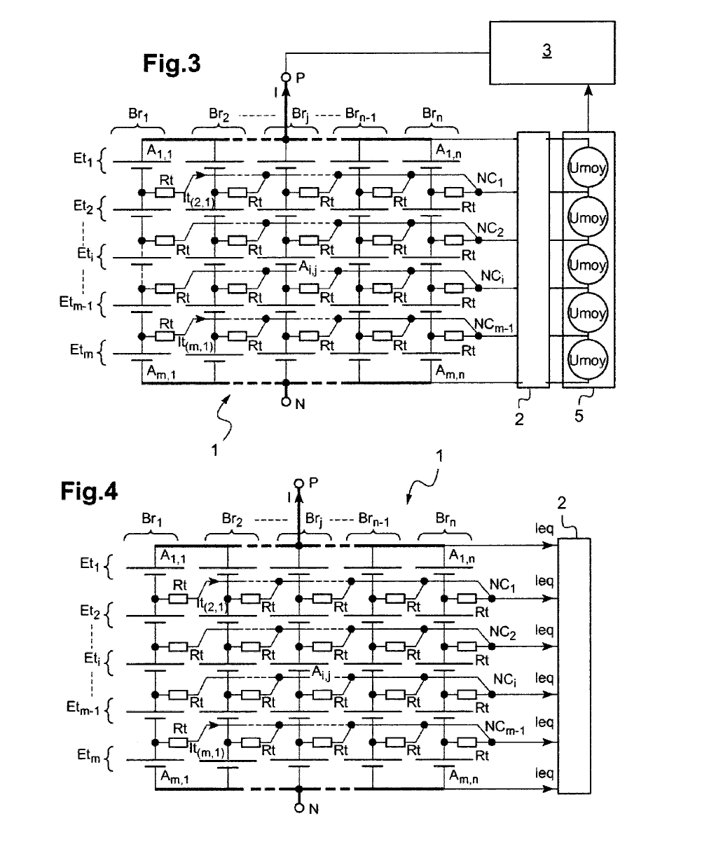

FIG. 3 is a schematic representation of a system comprising a battery module according to the invention, a balancing circuit, a voltage measuring device and a charger;

FIG. 4 is a schematic representation of the battery module of FIG. 2 showing a balancing current;

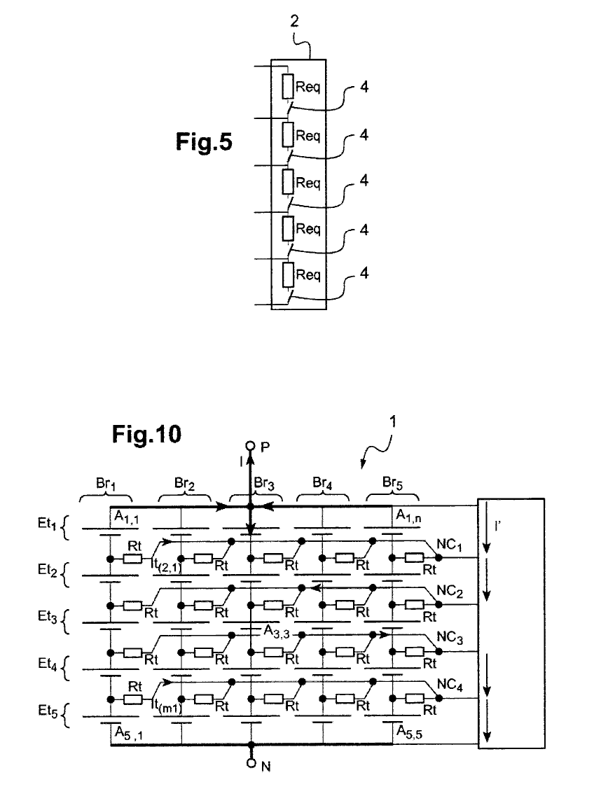

FIG. 5 illustrates an example of a balancing circuit comprising balancing resistors;

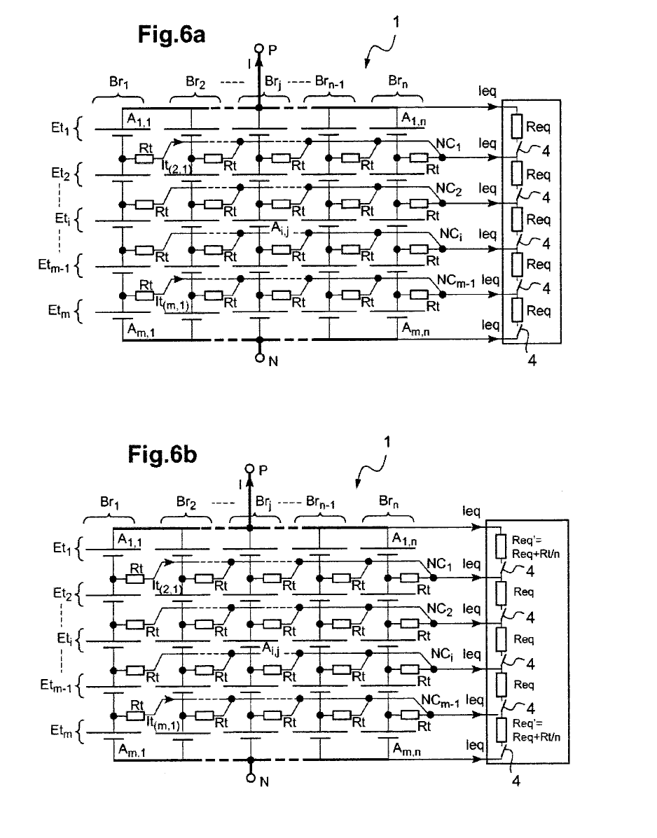

FIG. 6a is a schematic representation of a system comprising the battery module of FIG. 4 with the balancing circuit of FIG. 5;

FIG. 6b is a schematic representation of a system comprising the battery module of FIG. 2 with a balancing circuit according to a second embodiment;

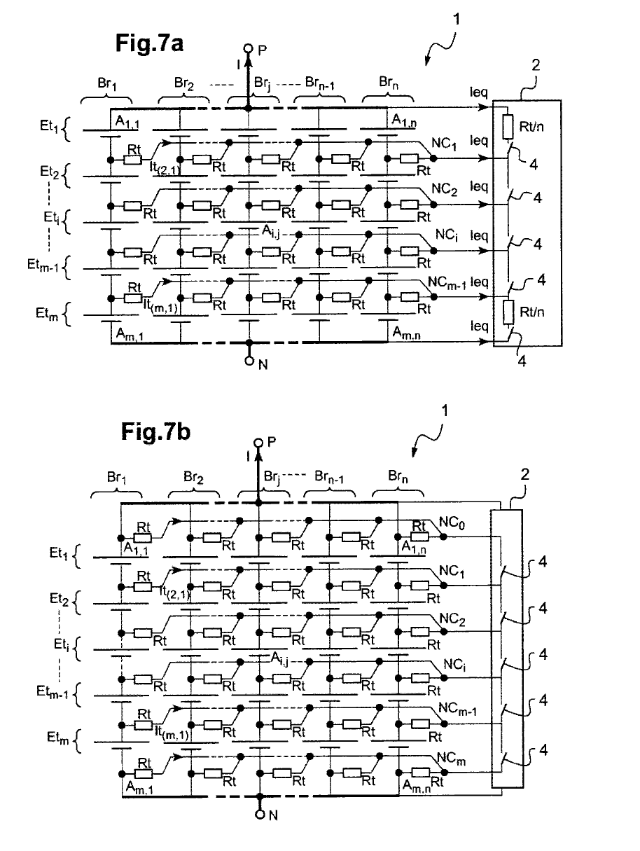

FIG. 7a is a schematic representation of a system comprising the battery module of FIG. 2 with a balancing circuit according to a third embodiment;

FIG. 7b is a schematic representation of a system comprising a variant of the battery module with a balancing circuit without balancing resistor;

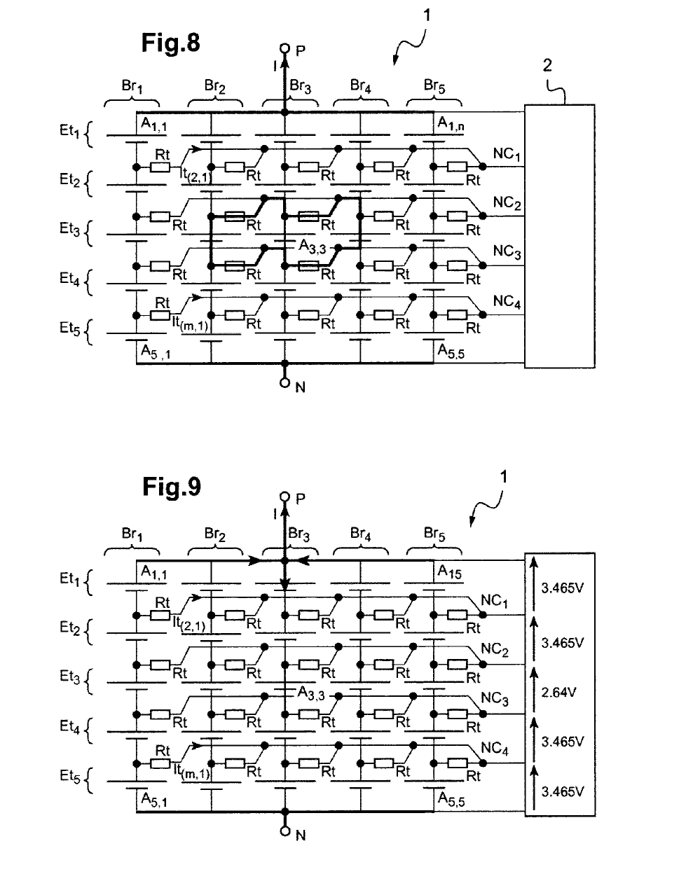

FIG. 8 is a schematic representation of the battery module of FIG. 2 upon a malfunction of an accumulator of the battery module;

FIG. 9 schematically illustrates the external currents upon the malfunction of an electrochemical cell of the battery module of FIG. 8;

FIG. 10 schematically illustrates the circulation of a current originating from the balancing circuit upon the malfunction of an electrochemical cell of the battery module;

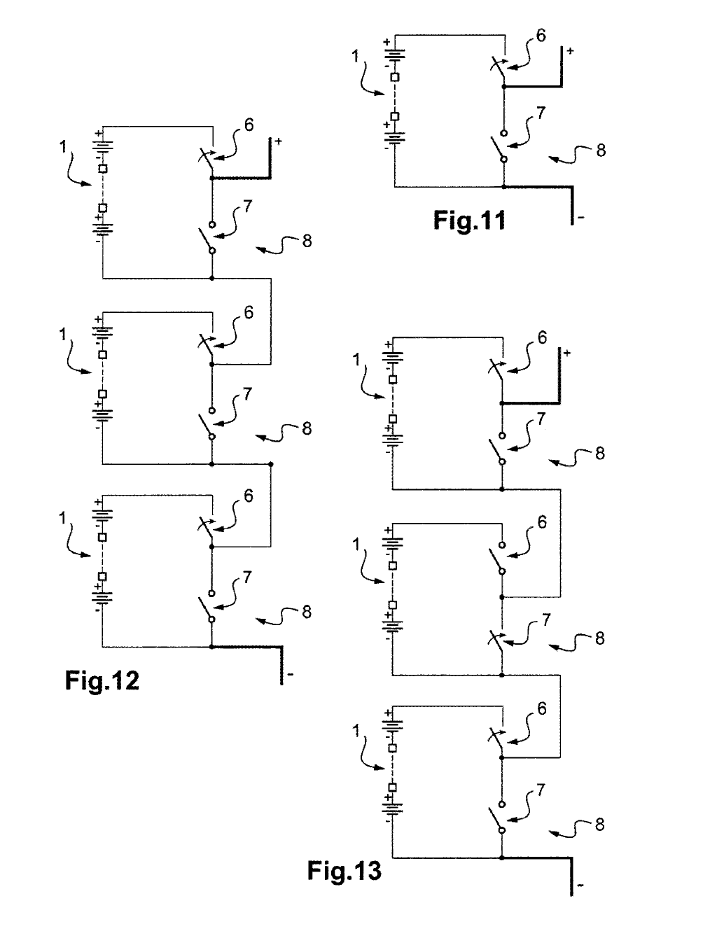

FIG. 11 schematically represents a battery module switched to isolated mode;

FIG. 12 schematically illustrates a battery including a plurality of modules of FIG. 11 in a normal operating mode; and

FIG. 13 illustrates the battery of FIG. 12 in a mode of operation in which one of the modules includes a failing accumulator.

### SYSTEM

FIG. 2 schematically represents a system comprising an accumulator battery module 1 according to the invention and a charge control device.

The battery module 1 has a negative pole N and a positive pole P that are of large sections.

The charge control device notably comprises a balancing circuit 2 connected to the poles P and N of the battery module 1. The charge control device can further comprise a charger 3 connected to the battery module 1 for charging the battery module 1 (see FIG. 3).

Battery Module

The invention applies in particular to the battery modules of lithium-ion iron phosphate LiFePO4 technology.

An accumulator according to the LiFePO4 technology has a great voltage tolerance. In effect, according to the LiFePO4 technology, the maximum voltage is of the order of 4.5 V, the margin between the end-of-charge voltage and the destruction voltage of the accumulator is significant, unlike with the other lithium chemistries. In effect, the specified end-of-charge voltage is 3.6 V, therefore the voltage margin is of the order of 1 V. For the other chemistries which have an end-of-charge voltage of the order of 4.2 V, the margin is only 0.3 V between the end-of-charge voltage of the order of 4.2 V and the maximum voltage of the order of 4.5 V.

The battery module 1 is produced in the form of a matrix comprising at least two columns and at least two rows, for example n columns and m rows.

The battery module 1 comprises at least two branches Brⱼ (j=1 . . . n) forming the columns of the matrix. Each branch Brⱼ comprises at least two accumulators A_{i,j} connected in series. Also, these branches are connected in parallel by their ends. The ends of the branches Brⱼ are linked to the poles P and N.

Furthermore, the branches Brⱼ have the same number of accumulators in series.

An accumulator stage Etᵢ is defined by all the accumulators which correspond to a same index i on a row of the matrix defining the battery module 1.

More specifically, the battery module 1 comprises a predefined number n of branches Brⱼ and a predefined number m of stages Etᵢ. The index i is a natural number corresponding to the number of accumulator stages and varies from 1 to m, and the index i is a natural number corresponding to the number of branches and varies from 1 to n.

Each stage Etᵢ comprises at least two accumulators or electrochemical cells. Each stage Etᵢ comprises a predefined number n of accumulators A_{i,j}. The index j also corresponds to the number of accumulators in a stage Etᵢ and varies from 1 to n.

The accumulators A_{i,j} are advantageously chosen to be similar. In the case of accumulators of unequal quality or of different state of charge, it is possible to perform a slower first initial charge so as to allow time for the accumulators to balance. With this charge being done only once at the end of manufacture of the battery, its impact can be considered as minor because it is only time-consuming for a battery constructor. This is a trade-off between the cost and the balancing time and therefore a longer downtime on leaving the factory.

In the example illustrated in FIG. 2, the first branch Br₁ includes accumulators A_{1,1} to A_{m,1} connected in series. The second branch Br₂ includes accumulators A_{1,2} to A_{m,2} connected in series. The branch Brⱼ includes accumulators A_{1,j} to A_{m,j} connected in series. The last branch Brₙ includes accumulators A_{1,n} to A_{m,n} connected in series.

The battery module 1 therefore comprises at least one matrix of m accumulator stages Etᵢ and of n accumulator branches Brⱼ in parallel.

In all the columns of the matrix formed by the branches Brj, the main charging and discharging current of the accumulators passes from the accumulator A_{i,j} to the accumulator A_{i+1,j} then to A_{i+2,j} and so on all along the series arrangement of the accumulators A_{1,j}, . . . , A_{i,j}, . . . , A_{m,j}, then this current is gathered together at the poles P and N via large-section electrical connections.

Each accumulator A_{i,j} of the matrix is connected electrically by a link rated for the charging and discharging currents with the accumulator A_{i+1,j}.

The battery module 1 further comprises secondary electrical links provided with resistors Rt between all the accumulators A_{i,j}.

More specifically, the battery module comprises a plurality of resistors Rt respectively linked electrically to the intermediate point between two accumulators A_{i,j}, of two adjacent accumulator stages Etᵢ, Etᵢ₊₁ and a third predefined number p of connection nodes NCᵢ respectively connected to a set of n resistors Rt connected to the intermediate points of the accumulators A_{i,j}, A_{i+1,j} of two adjacent accumulator stages Etᵢ, Etᵢ₊₁.

More specifically, the battery module 1 comprises at least one row of n resistors Rt connected to the accumulators A_{i,j}, A_{i+1,j} of two adjacent accumulator stages Etᵢ, Etᵢ₊₁.

In the example illustrated, the battery module 1 comprises the predefined number p of rows of resistors Rt.

According to the embodiment illustrated in FIG. 1, this third predefined number p bearing out the relationship (1):

(1) p=m−1 in which m is the number of accumulator stages Etᵢ. Each row of resistors Rt comprises n resistors Rt, that is the same number as accumulators A_{i,j} in an accumulator stage Etᵢ.

The resistors Rt of a row of resistors are respectively linked electrically on the one hand between a first accumulator A_{i,j} and a second accumulator A_{i+1,j} in series in a branch Brⱼ and on the other hand to a connection node called common connection node NCᵢ (i=1 . . . m−1) to all the n resistors Rt of the row of resistors.

Thus, all of the accumulators A_{i,j} of a stage Etᵢ have a terminal connected to a common connection node NCᵢ via resistors Rt.

The other terminal of the accumulators A_{i,j} can be connected to another common connection node NCᵢ via other respective resistors Rt. In the case of the end accumulator stages Et₁ and Etₘ, the other terminal of the accumulators A_{i,j} (j=1 . . . n) and A_{m,j} (j=1 . . . n) can be connected to a pole P or N of the battery module 1.

Thus, in the example illustrated in FIG. 2, the resistors Rt of the first row of resistors connect the negative terminals of the accumulators A_{1,j} of the first stage Et₁ to the common connection node NC₁ and on the other hand connect the positive terminals of the accumulators A_{2,j} of the second stage Et₂ to this common connection node NC₁.

More generally, the resistors Rt of the row of resistors of order i connect the negative terminals of the accumulators A_{i,j} of the stage Etᵢ to the common connection node NCᵢ and on the other hand connect the positive terminals of the accumulators A_{i+1,j} of the second stage Etᵢ₊₁ to this common connection node NCᵢ.

Furthermore, the charge control device is also connected to all the common connection nodes NCᵢ.

According to the embodiment illustrated, the balancing circuit 2 is connected to the common connection nodes NCᵢ.

During a charging or discharging phase, the main current in a branch passes through all the accumulators connected in series in that branch. During such operation, if all the accumulators A_{i,j} are similar and exhibit a same state of charge or of discharge, no cross-current circulates through the resistors Rt.

The rating of the resistors Rt is defined by a trade-off between different parameters which are to be acted upon, such as:
the maximum DC current accepted in a branch Brⱼ,
the discharging time of a stage Etᵢ comprising a faulty accumulator A_{i,j},
the balancing current Ieq (see FIG. 4) corresponding to the current exchanged by a stage Etᵢ with the balancing circuit 2,
the balancing time of the accumulators of a same branch Brⱼ, this being able to be a function of the slow or rapid recharging mode,
an easier end-of-charge detection, all the more easy when the number of accumulators A_{i,j} in parallel is small.

The rating must therefore be done as a function of the architecture of the module and of the accumulators used.

This solution can be produced with resistors Rt of high value (several ohms, even several tens of ohms) so as to limit the balancing current between accumulators and therefore the overheating of an accumulator in case of short-circuit while having a balancing time compatible with the application.

As an illustrative example, the range of values of the resistors Rt can be of the order of 10Ω to 1 kΩ. The resistors Rt can for example be chosen with a value of the order of 50Ω.

Moreover, the voltage measured at the common node NCᵢ corresponds to the average voltage of the accumulators A_{i,j}.

To this end, the charge control device can comprise a device 5 for measuring the average voltage of the accumulator stages Etᵢ (see FIG. 3). This average voltage measuring device 5 is linked electrically to the common nodes NCᵢ to which are respectively connected the accumulator stages Etᵢ via the resistors Rt and to the terminals P and N of the battery module 1.

The invention is distinguished from the prior art by the measurement of the average voltage of a given stage whereas conventionally, in the prior art, the measurement of the voltage of all the accumulators is demanded. For this, in the prior art, the parallel connection of the accumulators by high-current link or by fuses means that all the accumulators of the given stage have the same voltage.

Furthermore, such a structure makes it possible, in particular for the battery modules of LiFePO4 type, to know if the voltages of the accumulators A_{i,j} are correct and easily determine a failing zone of the battery module 1.

To recall, the plateau voltage is for example of the order of 3.3 V. If the measured average voltage is of the order of this plateau voltage added to a given threshold, for example is of the order of 3.4 V, the accumulators are considered to respectively exhibit a minimum voltage equal to this plateau voltage of 3.3 V. In effect, by construction, the dispersion of the accumulators according to the LiFePO4 technology is small, notably of the order of 10%, so when the measured average voltage is of the order of 3.4 V, the accumulators of this stage all have a voltage at least of the order of 3.3 V.

The average voltage Umoy informs as to the voltages of the accumulators of the given stage to within 100 mV in the example described. A strategy for balancing the accumulators will be described hereinbelow in more detail.

Furthermore, if an accumulator is faulty, an average voltage will drop whereas the other average voltages will increase. By measuring the average voltage Umoy of each stage Etᵢ the balancing circuit 2 can thus detect a failure, by observing for example that one stage is discharging or charging differently from the other stages. Because a short-circuited accumulator remains connected in parallel to the other accumulators of the stage, it is possible to detect that the other accumulators are discharging progressively into the latter. This makes it possible to rapidly detect that an accumulator is faulty.

The operation in case of malfunction of an accumulator A_{i,j} will be detailed hereinbelow.

Balancing Circuit

The charge balancing circuit 2 is connected electrically to each of the stages Et₁ to Etₘ, as described previously, by the common nodes NCᵢ and are also linked to the terminals N and P of the battery module 1.

The balancing circuit 2 is configured to implement a charge balancing of the accumulators A_{i,j} of these stages Etᵢ based on the tracking of their state of charge. A balancing strategy will be described in more detail hereinbelow.

The balancing circuit 2 comprises a predefined number of balancing resistors Req.

More specifically, the balancing circuit 2 comprises, according to a first embodiment illustrated in FIGS. 5 and 6a, a first balancing resistor Req in series with a switch 4 for each accumulator stage Etᵢ.

The value of the first balancing resistors Req is chosen as a function notably of the performance of the accumulators used, of the desired balancing time, and of the dissipation that can be accepted in the resistor, the electronic support, and more generally the battery module.

These first balancing resistors Req can have a value of the order of 10 ohms.

The first resistors Req and associated switches 4 in series arranged at the end position can be connected on the one hand to a terminal P or N of the battery module 1 and on the other hand to the common connection node NCᵢ.

The balancing current leg is defined by the first balancing resistors Req but also the resistors Rt which, when the switches 4 are closed, are then arranged in series with the first balancing resistors Req.

For the intermediate stages Et₂ to Etₘ₋₁, the equivalent resistance of the circuit corresponds to a first balancing resistor Req added to two times a resistor Rt divided by the number n of resistors Rt, according to the relationship (2):

$$Equivalent resistance for an intermediate stage = Re q + \frac{2 \times Rt}{n} . \qquad ( 2 )$$

In effect, in case of closure of the switch 4 associated with an intermediate stage, the current would pass through all the resistors Rt connected to the first terminals of the accumulators of this stage, via the first balancing resistor Req, then once again through the resistors Rt connected to the second terminals of the accumulators of this stage.

For the end stages Et₁ and Etₘ, the equivalent resistance corresponds to a first balancing resistor Req added to a resistor Rt divided by the number n of resistors Rt, according to the relationship (3):

$$Equivalent resistance for an end stage = Req + \frac{Rt}{n} . \qquad ( 3 )$$

The equivalent resistance is therefore lower for the end stages Et₁ and Etₘ, and the current is therefore stronger.

In this case, to obtain equivalent balancing currents Ieq, it is possible, according to a second embodiment illustrated in FIG. 6b, to provide, in the balancing circuit 2, two second balancing resistors Req′ for the end stages Et₁ and Etₘ, the second balancing resistors Req′ being, according to the relationship (4), equal to a first resistor Req added to a resistor Rt divided by the number n of resistors Rt:

$${Req}^{′} = Req + \frac{Rt}{n} \qquad ( 4 )$$

Thus, according to the second embodiment that can be seen in FIG. 6b, the balancing circuit 2 comprises a first balancing resistor Req in series with a switch 4 for each intermediate accumulator stage Et₂ to Etₘ₋₁, and, for the end stages Et₁ and Etₘ, a second balancing resistor Req′ also in series with a switch 4.

It is moreover possible to provide a variant embodiment that makes it possible to eliminate at least some of the balancing resistors, in particular the first balancing resistors Req of the embodiment illustrated in FIG. 6b, because the resistors Rt can serve as balancing resistor, as illustrated in FIG. 7a.

This has the advantage of distributing power to be dissipated in the balancing over n resistors instead of just one. This can help to reduce the overall cost of the solution by using SMC (surface mounted component) resistors. This solution is also suitable for balancings that require significant power.

In particular according to the embodiment of FIG. 7a, the balancing circuit 2 comprises two balancing resistors in the end stages Et₁ and Etₘ, respectively in series with a switch 4, and, for each intermediate accumulator stage Et₂ to Etₘ₋₁, an intermediate switch 4. The intermediate switches 4 are respectively linked to a common node NCᵢ connected to the accumulators of an intermediate stage Etᵢ.

In this case, to obtain equivalent balancing currents Ieq, the value of the first balancing resistors associated with the intermediate stages being zero, it is possible to provide, in the balancing circuit 2, for the two balancing resistors to be of the order of

$$\frac{Rt}{n}$$

for the end stages Et₁ and Etₘ.

Finally, according to another variant illustrated in FIG. 7b, the two balancing resistors associated with the end stages Et₁ and Etₘ of the variant of FIG. 7a have also been eliminated and n resistors Rt are distributed on the one hand connected with the terminals of the accumulators A_{1,j} and A_{m,j} of the end stages Et₁, Etₘ, and, on the other hand, with a pole P or N of the battery module 1.

According to the example illustrated, n resistors Rt are connected to the terminals of the accumulators A_{1,j} of the first stage Et₁ and to the pole P, and n other resistors Rt are connected to the terminals of the accumulators A_{m,j} of the last stage Etₘ and to the pole N.

With such an arrangement, each accumulator A_{i,j} is connected to a resistor Rt at each of its terminals.

The additional resistors Rt connected to the pole P are linked to a common node NC₀ and the additional resistors Rt connected to the pole N are linked to a common node Ncₘ. In this case, the third predefined number bears out the following relationship (5):

p=m+1. (5)

By placing the resistors Rt as close as possible to the accumulators A_{i,j}, it is possible to have a heat source that can be used to heat up the latter in case of use of the battery module in cold weather. This function can be used to heat up the battery module or to keep it at temperature to optimize its performance levels.

The resistors Rt make it possible to maintain the temperature of the accumulators A_{i,j} or heat them up in cold weather, for example by a transfer of heat to the two terminals of the accumulators A_{i,j}.

Moreover, according to this variant, all the accumulator stages Et₁ to Etₘ are identical.

Balancing Strategy

A balancing strategy according to the invention consists in waiting for the average voltage Umoy of a stage Etᵢ to reach an end-of-plateau voltage, for example of the order of 3.3 V plus a threshold chosen for an accumulator battery 1 according to the LiFePO4 technology. For this, the measuring device 5 can measure the average voltage Umoy of a stage Etᵢ.

When this end-of-plateau voltage, for example 3.3 V, added to a chosen balancing trigger threshold, is reached a charging stop command signal originating for example from the measuring device 5 is transmitted to the charger 3 to stop the charging of the battery module 1 and order the balancing between the stages Et₁ to Etₘ. In this case, the average voltage measuring device 5 is suitable for controlling the charger 3.

To recap, the voltage measured at the common node NCᵢ represents the average voltage Umoy of the accumulators A_{i,j} (j=1 . . . n) of the given stage Etᵢ.

For the accumulators according to the LiFePO4 technology, the plateau corresponding to a charge between 10% and 90% is of the order of 3.3 V. If an imbalance occurs, this will therefore be between this plateau voltage of 3.3 V and the end-of-charge voltage that is generally of the order of 3.6 V.

The maximum deviation is therefore of the order of 0.3 V. This maximum deviation is divided by the number n of branches Brⱼ of the battery module 1 and becomes 0.3 V/n.

This value of 0.3 V/n can be the starting point for a preferred balancing solution to define the balancing trigger threshold to be added to the plateau voltage of 3.3 V to stop the charging and commence the balancing. According to the example described, a choice is made to stop the charging as soon as the measured average voltage reaches 3.3 V+0.3 V/n, for example 3.36 V for a battery module 1 comprising five branches Brⱼ.

The average voltages Umoy of the accumulator stages Etᵢ are compared with one another, so as to determine at least one accumulator stage Etᵢ of average voltage lower than the average voltage of the other accumulator stages.

The switches 4 of the balancing circuit 2 associated with the stages of higher voltage, that is to say of average voltage higher than the accumulator stage determined to be of lower average voltage, are closed.

The accumulators of the accumulator stage or stages of higher average voltage discharge into the balancing circuit 2, for example through a balancing resistor Req or Req′ or

$$\frac{Rt}{n} .$$

The discharging of the accumulators of the stage during the balancing is represented by the balancing current Ieq circulating from the accumulator stages to the balancing circuit 2 to discharge for example into the balancing resistors Req or Req′ or

$$\frac{Rt}{n} .$$

The balancing current in each accumulator A_{i,j} corresponds to the balancing current Ieq divided by the number n of branches Brⱼ, that is

$$\frac{Ieq}{n} .$$

The balancing current in each accumulator is therefore very low. In the case where the balancing current Ieq is of the order of 250 mA, the balancing current

$$\frac{Ieq}{n}$$

passing through each accumulator A_{i,j} of a stage Eti is therefore of the order of 250 mA/n, i.e. a few tens of mA at most for ten accumulators A_{i,j} in parallel.

A cross-current It_{i,j} circulates through the resistors Rt.

This operation can be done for a number of stages at the same time.

However, with a balancing circuit according to the variant represented in FIG. 7, it is preferable not to close two successive switches. In effect, two switches closed in series would modify the balancing current. In this case, the resistors Rt would be passed through by a double current. To remedy this, it must be taken into account in the rating of the resistors Rt to allow the circulation of a higher current.

One variant is to provide a balancing by sequencing of two successive accumulator stages.

When the average voltage Umoy of the accumulators A_{i,j} of a given stage Etᵢ no longer varies with time, the stage Etᵢ is balanced.

The balancing operation is repeated until the average voltages of the stages of higher voltage reach the average voltage of the stage of lower voltage.

When the balance is reached between the average voltages Umoy of the accumulator stages Etᵢ the charging of the battery module 1 recommences.

The chosen threshold can be progressively increased to speed up the balancing. Thus, as the stage balances, the measured average voltage value can be raised to 3.6 V and therefore a full charge of the stage to 100% is obtained. It is possible in the example described to have a threshold that changes as follows: 3.36 V 3.40 V-3.45 V-3.50 V-3.55 V-3.60 V.

The final stopping of charging takes place, by way of example, when all the stages are at 3.6 V.

A final charge stopping threshold lower than 3.6 V can be chosen, for example between 3.3 V and 3.6 V.

Malfunction

The voltage measuring device 5 will be able to determine the presence of a failing accumulator by identifying a stage, at the terminals of which the voltage varies abnormally relative to the other stages, either during a charge, or during a discharge.

It is also possible to identify a stage containing a failing accumulator from a significant variation of its discharge rate or from its voltage level since it discharges progressively.

In case of accidental short-circuiting of an accumulator A_{i,j} of a branch Brⱼ, the neighboring accumulators will inject a current into the short-circuited accumulator which will be limited by the resistors Rt. In effect, when an accumulator forms a short-circuit, the other accumulators of the stage discharge into this accumulator, because of the large section of the electrical connections between them.

In the example of FIGS. 8 and 9, the accumulator A_{3,3} suffers a short-circuit malfunction.

The neighboring accumulators will inject a current into the short-circuited accumulator A_{3,3}.

Because of the presence of the resistors Rt, the currents between the branches are low because they are limited by the resistors Rt. The use of resistors Rt therefore makes it possible to protect the accumulators A_{i,j} simply and inexpensively.

More specifically, following the appearance of the malfunction, because of the presence of the resistors Rt, the cross-charge currents originating from the neighboring accumulators are relatively limited. In the neighboring branches of the faulty accumulator A_{3,3} (represented in bold in FIG. 8), the current is limited at a value close to

$$\frac{Vacc}{2 R}$$

(where Vacc is the voltage of an accumulator, R the value of a resistor Rt). The current is limited

$$\frac{Vacc}{R}$$

in the faulty accumulator A_{3,3}.

This current is low, for example less than 100 mA, which will contribute to discharging the stage Et3 containing the faulty accumulator A_{3,3} very slowly.

Thus, the overcurrent is limited in amplitude and the faulty accumulator A_{3,3} dissipates only a small quantity of energy coming from its neighbors. There is no risk of violent overheating. The risk of starting a fire is eliminated or greatly minimized.

Subsequently, the faulty stage Et₃ discharges slowly and totally into the short-circuited accumulator A_{3,3}.

Moreover, it is considered that the accumulators A_{i,j} respectively exhibit a voltage of the order of the plateau voltage, that is 3.3 V, in normal operation. In the case of the accumulator A_{3,3} developing a fault, the measured average voltage Umoy of the stage Et3 will drop by a value corresponding to the plateau voltage, that is 3.3 V, divided by the number n of branches Brⱼ, five in the example of FIGS. 8 and 9, that is

$$\frac{3.3 V}{5} .$$

Thus, in this example, the average voltage Umoy of the stage Et3 comprising the faulty accumulator A_{3,3} will be of the order of 2.64 V (see FIG. 9).

Moreover, in normal operation, a branch Brⱼ exhibits a voltage of the order of the plateau voltage 3.3 V multiplied by the number m of stages Etᵢ therefore, in the example illustrated with five stages Etᵢ, the voltage of a branch Brⱼ is of the order of 3.3 V×5, that is 16.5 V.

The branch Brⱼ having the faulty accumulator A_{3,3} will drop by a value of the order of the plateau voltage of the accumulators, here 3.3 V, that is 16.5 V to 13.2 V.

With the branch Br₃ having its voltage dropped from 16.5 V to 13.2 V, a significant current I circulates through the ends (see FIG. 9). The current circulating in the transverse branches contributes to recharging the accumulators in series with the faulty accumulator by the external connections of the battery module 1 as shown in FIG. 9.

This transient current thus distributes the plateau voltage over the accumulators in series with the faulty one by recharging them.

This overvoltage in the healthy accumulators in series with the faulty accumulator depends on the number of accumulators in series and can therefore be greatly reduced if the number of accumulators is significant, the overvoltage is of the order of the plateau voltage divided by the number of healthy accumulators in series with the faulty accumulator according to the relationship (6):

$$overvoltage = \frac{Uplateau}{m - 1} \qquad ( 6 )$$

in which Uplateau is the plateau voltage, here 3.3 V, and m is the number of stages Etᵢ.

This will therefore contribute to strongly recharging the healthy accumulators remaining in the branch Br₃. More specifically, in the example of FIGS. 8 and 9 with five stages Etᵢ there remain four healthy accumulators in the branch Br₃ comprising the faulty accumulator A_{3,3}. These four remaining accumulators therefore share the plateau voltage of the order of 3.3 V. Thus, each of the remaining accumulators increases by a voltage of the order of

$$\frac{3.3 V}{4} ,$$

that is 0.825 V. The remaining healthy accumulators therefore exhibit a voltage of the order of 4.125 V. This is possible with the accumulators of LiFePO4 technology which accept a wide voltage range before the degradation of the electrolyte, this occurring only beyond 4.5 V.

Thus, the measuring device 5 measures a voltage which has dropped relative to the plateau voltage, for example here 2.64 V for the stage Et₃ comprising the faulty accumulator A_{3,3} whereas it measures an average voltage which has increased on the remaining stages, for example here 3.465 V, corresponding to the average of four accumulators at 3.3 V and one accumulator in series with the faulty accumulator A_{3,3} at 4.125 V.

This drop in the average voltage of a stage while the average voltage of the other stages increases allows for an instantaneous detection of the internal short-circuit.

Subsequently, the accumulators of the branch Br₃ comprising the faulty accumulator A_{3,3} and exhibiting an overvoltage as explained previously, discharge into the neighboring accumulators of the stage concerned. Thus, apart from the stage Et₃ comprising the faulty accumulator fully discharging, the other stages progressively converge to a voltage close to the plateau voltage at 3.3 V.

In conclusion, it is easy to detect the presence of a fault by the measurement of the average voltages at the common nodes by detecting a variation of the average voltage on the common node. This is all the easier when the number of cells in parallel is small.

Another detection mode can be to observe the discharging of the accumulators in parallel into the faulty accumulator.

The fault of a given accumulator will cause, over all of the battery module 1, a full discharge of the stage where the fault has appeared within a time dependent on the number of cells in parallel and on the current level limited by the resistors Rt. Nevertheless, this discharging according to the rating of the resistors can be very slow, notably of the order of several hours which has the effect of being able to continue to use the battery module 1.

It may even be possible to carry out a number of charging or discharging cycles before either isolating the battery module 1 or immobilizing the vehicle to repair it.

Furthermore, it remains possible to balance if the current passing through the resistor Rt linked to the faulty accumulator A_{3,3} is less than a current I′ originating from the balancing circuit 2. Referring to FIG. 10, the discharge current originating from the accumulators of the stage Et₃ comprising the faulty accumulator A_{3,3} can be totally or partially compensated by the current I′ originating from the balancing circuit 2, according to the rating of the balancing resistors Req, Req′.

This makes it possible to avoid having the accumulators neighboring the faulty accumulator A_{3,3} discharge into the latter.

Battery

FIG. 11 shows a switched module, that is to say a battery module 1 as defined previously associated with a first power switch 6 and a second power switch 7.

The first switch 6 is arranged in series with the battery module 1.

The second switch 7 is arranged to bypass the battery module 1.

The switches 6 and 7 can be transistors of MOSFET type, which can easily be rated appropriately at a relatively low cost.

The control device is suitable for controlling the closure and the opening of the switches 6, 7. The switches 6, 7 form an isolating device 8 for the associated battery module 1.

In normal operation of the battery module 1, the first switch 6 is configured to be closed and the second switch 7 is configured to be open.

To isolate a battery module 1, the opening of the first switch 6 is commanded and the closure of the second switch 7 is commanded.

Moreover, a storage device, also called battery, for example whose nominal voltage is for example greater than 100 V, generally comprises a plurality of battery modules 1 connected in series as illustrated in FIG. 12.

The battery has two power output poles + and −.

Each battery module 1 is as defined previously with a number of accumulator stages Etᵢ in series defining a number of branches Brⱼ in parallel and is associated with two power switches 6, 7.

In the configuration illustrated in FIG. 12, the battery modules 1 are all operational. Consequently, their first associated switches 6 are closed and their second associated switches 7 are open, such that the battery modules 1 are connected in series.

In the case where an accumulator is failing in one of the battery modules 1, the control device can advantageously command this battery module 1 to be short-circuited in order to ensure the continuity of service of the rest of the battery.

In particular, in the case where the accumulator stage Etᵢ comprising the faulty accumulator is fully discharged, it is preferable to isolate it to be able to continue to use the rest of the battery. The principle is to isolate a faulty battery module 1.

To do this, referring to FIG. 13, when the control device detects a malfunction as explained previously by tracking the average voltages of the stages Etᵢ, the first switch 6 is opened and kept open in order to automatically isolate the battery module 1 in case of malfunction. The closure of the second switch 7 is controlled.

The battery can be used in degraded mode assuring continuity thereof.

Thus, the protection system as described previously makes it possible to obtain lithium-ion batteries tolerant to short-circuit or open-circuit failure of an accumulator, provided with balancing circuits to maximize the life of the accumulators A_{i,j}, with the advantage of minimizing the number of circuits for balancing and monitoring the high and low voltages of all the accumulators.

For this, the resistors Rt links the accumulators of a stage to a common connection node NCᵢ on which the average voltage Umoy of the stage can be measured.

With respect to the balancing, this solution runs counter to preconceptions in the technical field of battery balancing because the monitoring is done by tracking the average voltage at the common node and not by measuring the voltage of each accumulator, and because of this, a person skilled in the art would consider that this solution does not make it possible to perform a balancing between the accumulators in a simple manner.

The detection of a faulty accumulator can occur instantaneously without having to wait for the full discharging of the accumulator stage comprising the accumulator by detection of a variation of the average voltage at the common node, for example a drop in the average voltage of one stage while the voltages of the other stages increase.

Moreover, the resistors Rt are simple components that make it possible to limit the current at lesser cost to protect the accumulators in case of short-circuiting in particular.

Another advantage is the idea of protection of this solution. By using resistors Rt of relatively high values, the DC current is limited. Consequently, the opening of the vent of the faulty accumulator will be done at low current but also at low temperature. The function of this vent is to avoid the formation of pressure when the battery temperature rises. This therefore contributes to not further increasing the pressure within the accumulator and therefore to a less violent vent opening.

Finally, the distribution of the resistors Rt within the battery module 1 ensures a better heat distribution. In particular, the plurality of resistors Rt makes it possible to heat up or maintain the temperature of the accumulators A_{i,j} of the battery module 1 notably in case of use in cold weather.

1-19. (canceled)

20. A protection system for a battery module, comprising:
at least one battery module having a positive pole (P) and a negative pole (N) and defined by a matrix comprising a first predefined number n of columns, n being greater than or equal to two, and a second predefined number m of rows, m being greater than or equal to two, the matrix being such that:
each column defines a branch (Br_{j (j=1 . . . n)}) of accumulators having m accumulators (A_{i,j}) in series, the branches (Brⱼ) of accumulators being linked by their ends in parallel and to the poles (P, N) of the battery module, and
each row of the matrix defines an accumulator stage (Etᵢ); and
at least one charge control device connected to the poles (P, N) of the battery module, wherein the battery module further comprises:
a plurality of resistors (Rt) respectively linked electrically to the intermediate point between two accumulators (A_{i,j}, A_{i+1,j}) of two adjacent accumulator stages (Etᵢ, Etᵢ₊₁) and
a third predefined number p of connection nodes (NCᵢ) respectively connected to a set of n resistors (Rt) connected to the intermediate points of the accumulators (A_{i,j}, A_{i+1,j}) of the two adjacent accumulator stages (Etᵢ, Etᵢ₊₁), and
wherein the charge control device comprises at least one balancing circuit linked electrically to all the connection nodes (NCᵢ), such that:
the second predefined number m of rows of the matrix and the third predefined number p of connection nodes (NCᵢ) bear out the following relationship:
p=m−1;
the balancing circuit comprises
a plurality of switches each arranged in parallel to an accumulator stage (Etᵢ) by being connected to at least one connection node (NCᵢ), and
two balancing resistors (Req′) each associated with an end accumulator stage (Et₁, Etₘ), each being respectively in series with a switch associated with one of said end accumulator stages (Et₁, Etₘ) by being connected to at least one connection node (NCᵢ, NCₘ₋₁) and to one of the poles of the battery module.

21. The system as claimed in claim 20, in which the two balancing resistors (Req′) are of the order of
$${Req}^{′} = \frac{Rt}{n}$$
for the end accumulator stages (Et₁, Etₘ).

22. The system as claimed in claim 20, in which the balancing circuit comprises a plurality of balancing resistors (Req, Req′) respectively connected in series with a switch, the assembly comprising a balancing resistor (Req, Req′) and a switch in series being arranged in parallel to an accumulator stage (Etᵢ) by being connected to at least one connection node (NCᵢ), the balancing circuit comprising:
first balancing resistors (Req) respectively in series with a switch and associated with an intermediate stage (Et₂, Etₘ₋₁) by being connected to at least one connection node (NC₂ NCₘ₋₂) and
two second balancing resistors (Req′) respectively in series with a switch and associated with an end accumulator stage (Et₁, Etₘ) by being connected to at least one connection node (NC₁, NCₘ₋₁) and to one of the poles of the battery module, and in which a second balancing resistor (Req′) is in accordance with the formula:
$${Req}^{′} = Req + \frac{Rt}{n} .$$

23. The system as claimed in claim 22, in which the balancing circuit comprises m identical balancing resistors (Req) respectively associated with an accumulator stage (Etₐ).

24. The system as claimed in claim 20, in which said resistors (Rt) are identical.

25. The system as claimed in claim 20, further comprising accumulators of lithium-ion iron phosphate LiFePO4 type.

26. The system as claimed in claim 20, in which the charge control device comprises an average voltage measuring device linked electrically to the terminals of the battery module and to all the connection nodes (NCᵢ) and suitable for measuring the average voltages (Umoy) of the accumulator stages (Etᵢ).

27. The system as claimed in claim 26, in which said control device is configured to detect a malfunction of the battery module by tracking the average voltage (Umoy) at the terminals of the accumulator stages (Etᵢ).

28. The system as claimed in claim 27, in which said control device is configured to detect a malfunction of the battery module when the average voltage (Umoy) at the terminals of at least one of said accumulator stages diverges from the average voltages (Umoy) at the terminals of the other accumulator stages (Etᵢ).

29. The system as claimed in claim 28, in which said control device is configured to detect a malfunction of the battery module when the average voltage (Umoy) at the terminals of at least one accumulator stage drops and the average voltages (Umoy) of the other accumulator stages (Etᵢ) increase.

30. The system as claimed in claim 20, in which said control device is configured to detect a malfunction of the battery module in case of discharge of at least one accumulator stage (Etᵢ).

31. The system as claimed in claim 20, further comprising:
at least two of the battery modules arranged in series, and
an isolating device respectively associated with each battery module and comprising a first switch and a second switch,
the first switch being arranged in series with the associated battery module and configured to be closed when the associated battery module is operational and open in case of malfunction of said battery module, and
the second switch being arranged to bypass the associated battery module and configured to be open when the associated battery module is operational and closed in case of malfunction of said battery module.

32. The system as claimed in claim 31, in which said control device is suitable for applying a signal controlling the opening of the first switch and for applying a signal controlling the closure of the second switch associated with a battery module in case of detection of a malfunction of said battery module.
